(19) United States
(12) Patent Application Publication
(10) Pub. No.: US 2020/0385106 A1
(43) Pub. Date: Dec. 10, 2020

(54) AUTOGYRO

(71) Applicant: SCHOPPE DEVELOPMENT UG (HAFTUNGSBESCHRAENKT), MUEHLHAUSEN (DE)

(72) Inventor: RONALD SCHOPPE, MUEHLHAUSEN (DE)

(73) Assignee: SCHOPPE DEVELOPMENT UG (HAFTUNGSBESCHRAENKT), MUEHLHAUSEN (DE)

(21) Appl. No.: 16/764,392

(22) PCT Filed: Nov. 15, 2018
(86) PCT No.: PCT/DE2018/200104

§ 371 Date: Aug. 19, 2020

(30) Foreign Application Priority Data
Nov. 17, 2017 (DE) 20 2017 106 992.3

(51) Int. Cl. B64C 27/02; B64D 27/24; B64C 27/82; B64D 27/02; B64D 9/00; B64D 41/00

(52) U.S. Cl. CPC B64C 27/025; B64D 27/24; B64C 27/022; B64C 27/027; B64D 2027/026; B64D 27/02; B64D 9/003; B64D 41/00; B64C 2027/8236; B64C 27/82

(57) ABSTRACT

An autogyro includes a fuselage with a rotor. The rotor includes rotor blades which are arranged on an upper face of the fuselage, and a rotor drive which temporarily drives the rotor via a first motor. The rotor blades autorotate via an airflow.

### CROSS REFERENCE TO PRIOR APPLICATIONS

This application is a U.S. National Phase application under 35 U.S.C. § 371 of International Application No. PCT/DE2018/200104, filed on Nov. 15, 2018 and which claims benefit to German Patent Application No. 20 2017 106 992.3, filed on Nov. 17, 2017. The International Application was published in German on May 23, 2019 as WO 2019/096358 A2 under PCT Article 21(2).

### FIELD

The present invention relates to an aircraft in the form of a so-called autogyro comprising a fuselage, a rotatable rotor that is arranged on a mast on the fuselage which is made to autorotate by an airflow from below resulting from the forwards movement of the aircraft and in particular during flight. The present invention relates to a mass adjusting device for an aircraft, in particular an autogyro or helicopter. The present invention also relates to a combined transportation unit comprising a rechargeable battery and a transportation case.

### BACKGROUND

An uplift is generated via the autorotation. The thrust that is required for the forwards movement of the autogyro is generated by a motor-driven propeller that can, for example, be arranged in the rear region.

Generic-type autogyros are described, for example, in DE 11 2013 002 003 T5 and DE 20 2015 005 887 U1. Autogyros of this type require an appropriate take-off distance for take-off and landing. During take-off, a simple tilting-head control makes the rotor pre-rotate, during which the autogyro is not yet rotating about its own vertical axis. No further drive energy is thereafter introduced into the rotor during take-off and flight. The autorotation of the rotor that produces the uplift is here produced exclusively by the airflow. The rotor blades are usually attached to the rotor hub in a non-adjustable manner (fixed pitch), which renders it possible to provide a simple construction of the rotor system.

Generic-type autogyros comprising two propulsion propellers that are arranged to protrude sideward from the fuselage have also previously been described. The length of the runway required for take-off is reduced by increasing drive power and by improving aerodynamics.

Autogyros have also previously been described that comprise adjustable rotor blades which are consequently able to perform a vertical take-off. The vertical take-off in this case is a so-called jump take-off during which, while the blade is in a position that does not generate an uplift, the rotational speed of the rotor is increased to above the flight rotational speed. The rotor is subsequently decoupled from the drive and the rotor blades are adjusted into a position that generates an uplift. The inertia of the rotor system, which is mainly enhanced by weights on the rotor blade tips, thereafter causes the autogyro to take-off abruptly. It is, however, difficult to control take-offs of this type. A solution of this type is described in U.S. Pat. No. 5,727,754. The requirement of being able to adjust the rotor blades means that these solutions have costs similar to those for conventional helicopters.

### SUMMARY

An aspect of the present invention is to improve upon the prior art. An aspect of the present invention is in particular to provide an autogyro with which a controlled vertical take-off, a controlled hovering, and a controlled landing is possible.

In an embodiment, the present invention provides an autogyro which includes a fuselage which comprises a rotor. The rotor comprises rotor blades which are arranged on an upper face of the fuselage, and a rotor drive which is configured to temporarily drive the rotor via a first motor. The rotor blades are configured to autorotate via an airflow.

### BRIEF DESCRIPTION OF THE DRAWINGS

The present invention is described in greater detail below on the basis of embodiments and of the drawings in which:

FIG. 1 shows a lateral view of the autogyro of the present invention;

FIG. 2 shows a front view of the autogyro of the present invention;

FIG. 3 shows a plan view of the autogyro of the present invention during autorotation;

FIG. 4 shows a plan view of the autogyro of the present invention when a rotor is driven; and

FIG. 5 shows a schematic lateral view of the autogyro of the present invention having a mass adjusting device and a combined transportation unit arranged thereon.

### DETAILED DESCRIPTION

An autogyro in accordance with the present invention comprises a motor-driven rotor having non-adjustable or adjustable rotor blades that may by accelerated via the motorized drive to a take-off rotational speed that lies above the autorotation rotational speed during flight. In order to compensate the torque that consequently occurs during the take-off procedure and which causes the autogyro to rotate about its own vertical axis, the two propulsion propellers that protrude sidewards from the fuselage may be controlled so that it is possible to reverse the direction of thrust, in particular in the case of at least one propeller, via which it is possible to perform a classic controllable vertical take-off.

After take-off, the rotor drive is switched off in the generic manner and the forward flight commences during which the required uplift is only generated by the rotor autorotating. A controlled hover flight and a vertical landing are also possible in a similar manner to the take-off procedure.

It is possible to provide the drive of the rotor and the propellers using the most diverse drive concepts. One very advanced variant is a purely electric drive which drives the rotor and the propellers via battery-operated electric motors. It is therefore possible to control the rotational speed in a technically simple manner and also to reverse the thrust of the propellers by reversing the direction of rotation.

This also applies for a hybrid drive concept wherein the rotor is driven temporarily, and an electric generator is driven permanently by way of a non-electric drive motor, the electric motors of the propellers being supplied with energy by the electrical generator.

In particular in the case of variants that have a non-electrical drive of the propellers, it is also possible to reverse the direction of thrust by adjusting the propeller blades.

The present invention provides an autogyro comprising a fuselage having a rotor that has rotor blades arranged on the upper face of the fuselage which can be made to autorotate by an airflow, wherein the rotor comprises a rotor drive so that the rotor may be driven temporarily by a motor.

Autogyros that in particular do not comprise a rear rotor for stabilizing purposes may consequently take-off vertically.

The following terms are explained:

A “gyroplane”, also referred to as “autogyro” or “gyrocopter”, is in particular a rotary wing aircraft that functions in a similar manner to a helicopter. The rotor in this case is generally not, however, made to rotate by a power unit, but is rather made to rotate passively by the airstream. This procedure of making the rotor rotate is referred to as “autorotation”. The uplift is generated in this case by the resistance of the rotating rotor blade in the case of a rearward-inclined rotor axis. The propulsion is mainly provided by a propeller drive. Jet engines or other power units may also be used.

A “fuselage”, also referred to as a “gondola”, in particular forms the outer casing of a chamber that is provided for cargo and people.

The “upper face” of the fuselage is the part of the fuselage that is generally the furthest away from the ground.

An “airstream” in particular arises by virtue of the fact that during a movement relative to the air on an upper surface (in this case the fuselage and rotor blade), an airstream and consequently a relative movement with respect to the air occurs.

A “rotor” is in particular a rotating part of a machine and in particular comprises “rotor blades” in the current case. The rotor and the rotor blades are generally oriented in the horizontal direction, wherein, in the case of the autogyro, there is mostly a slight inclination with respect to the horizontal.

An important aspect of the present invention is in particular that the rotor with its associated rotor blades may be driven by a motor, wherein, during normal forward flight, a motor does not cause the rotor with its associated rotor blades to rotate.

In an embodiment of the present invention, the autogyro can, for example, comprise a first driven, thrust-generating propulsion-generating device, in particular propellers, and a second driven, thrust-generating propulsion-generating device, that are arranged on both sides of the fuselage and that protrude in the horizontal direction from the fuselage, and a thrust force of the first driven, thrust-generating propulsion-generating device and a thrust force of the second driven, thrust-generating propulsion-generating device may be adjusted independently of one another.

A “first driven, thrust-generating propulsion-generating device” and a “second driven, thrust-generating propulsion-generating device” are in particular arranged spaced apart from one another in the horizontal direction and exert a corresponding force on the autogyro that is generally used to create the forward flight.

An air screw, which is referred to here as “propeller”, can, for example, provide the propulsion. Other power units, such as jet engines, may also be used.

In order to render possible a vertical take-off and to compensate the rotor blades that are made to rotate by the motor and the resulting rotation of the fuselage, the first driven, thrust-generating drive and the second driven, thrust-generating drive may be adjusted independently of one another. It is additionally also possible to change the direction of the autogyro by applying this characteristic to the autogyro.

Thrust-direction reversing devices of the propulsion-generating devices may be used to compensate the rotational forces that are exerted on the fuselage during a vertical take-off with motor-driven rotor blades. These thrust-direction reversing devices in particular generate a thrust reversal.

When using propellers as propulsion-generating devices, the thrust forces may be adjusted by adjusting the propeller blades or by changing the rotational speed of the propellers. The thrust-direction reversing device may also be provided via the propellers, wherein the thrust reversal is in particular provided by adjusting the propeller blades and/or by changing the direction of rotation.

An important aspect of the present invention relates to the fact that, by virtue of a different control procedure of the first and second driven, thrust-generating drives and the motorized drive of the rotor with its rotor blades, a combination is provided which enables the autogyro to take-off vertically. In contrast to, for example, helicopters which use a permanent motor operation and in which the forward movement and also the lowering and raising of the autogyro is provided by changing the pitch of the rotor blades, in the case of current autogyros, this is provided with a fixed pitch angle of the rotor blades and without a rear rotor.

In an embodiment, the present invention provides a previously described autogyro that comprises a mass adjusting device so that, in particular in the case of a vertical take-off, the fuselage may be oriented in the horizontal direction and/or it is possible to control the direction of the autogyro. This renders it possible in the case of an autogyro in accordance with the present invention but also in the case of previously described autogyros or helicopters to orient the fuselage or to change the flight direction on the basis of displacing mass and consequently shifting the center of gravity of the corresponding aircraft.

In an embodiment, the mass adjusting device can, for example, comprise a mass element and an adjusting element.

The adjusting element provides that the mass is positioned within the fuselage so that this results in a significant shift of the center of gravity of the corresponding aircraft. To the extent the adjusting element provides a displacement in the three spatial directions, this may in turn be used to control or trim the aircraft or even also to orient the fuselage.

This is in particular relevant in the case of autogyros in accordance with the present invention since the fuselage of these autogyros is generally greatly inclined during a vertical take-off. This may cause discomfort for the passengers. By virtue of actively shifting the center of gravity, the fuselage may, however, be oriented, for example, in the horizontal direction, so that the flight sensation for the passengers is optimized. It is thus in particular possible to prevent a passenger from suffering air sickness.

In order to avoid an additional mass in the autogyro, the mass element may be a transport container, in particular a freight box, an energy storage device, in particular a battery block or a rechargeable battery, and/or a drive unit, in particular a motor.

If a transport container is used, after loading and prior to take-off, the weight of the transport container is determined, for example, via strain gauges, and is accordingly used via the open-loop control procedure and the control of the adjusting element of the transport container including the cargo as a mass element.

It is particularly advantageous if a mass is used that fundamentally does not change its weight and consequently its mass during use. In particular in the case of an electrically driven autogyro, this may, for example, be a rechargeable battery or, in the case of a hybrid or motorized autogyro, the motor itself.

It is in particular possible to use actuators as an “adjusting element”, each of which in particular position the mass in the three spatial directions, or a hexapod. The hexapod is in particular therefore advantageous since it is possible to control the corresponding spatial directions very efficiently via the hexapod. Hexapods are special forms of parallel kinematic machines and fundamentally comprise six legs and render possible a movement in six degrees of freedom (three translatory and three rotatory).

In order to use the mass displacement to control the aircraft and consequently to control the autogyro or also to orient the fuselage, the aircraft and in particular the autogyro in accordance with the present invention comprises a control device that controls the mass adjusting device in an open-loop and/or a closed-loop manner. During the open-loop control procedure, a predetermined signal is in particular provided by actuators, whereby in contrast thereto, corresponding measurement values are fed back during the closed-loop control procedure.

It is thus possible, for example, via the control lever in the aircraft, to control the adjusting element and accordingly to change the center of gravity so that a change of direction is in particular provided by the control lever. A corresponding trim procedure may also be performed.

Via the control procedure or the corresponding closed-loop control procedure, if, for example, a position sensor is provided that determines the position of the fuselage in space, it is also possible in the case of a vertical take-off of the autogyro to orient and control the fuselage in a closed-loop manner so that the fuselage is fundamentally oriented in the horizontal direction.

In an embodiment, the autogyro in accordance with the present invention comprises an electric drive or a hybrid drive, wherein the electric drive or the hybrid drive comprises a replaceable electrical energy storage device, in particular a rechargeable battery.

The aircraft does not thus need to permanently have a rechargeable battery that is dimensioned with a regard to a maximal charge, the aircraft may much rather be provided with a rechargeable battery that is sufficiently dimensioned with regard to its charge for the relevant task.

It is thus possible, for example, to provide more storage space for transporting goods or people.

In an embodiment of the present invention, an autogyro can, for example, comprise a replaceable transported goods case, wherein the replaceable transported goods case is coupled to the replaceable electrical energy storage device via a mechanical connection so that a combined transportation unit for transporting freight and for supplying energy to the electric drive or to the hybrid drive is provided and the combined transportation unit may be loaded or unloaded as a whole.

An important aspect of the present invention is consequently that the energy storage device and consequently the rechargeable battery together with the actual case for transportation of freight form an individual unit. This means that during the loading procedure and/or unloading procedure, not only a transportation case is loaded or unloaded with the corresponding freight, but additionally the rechargeable battery that is mechanically connected thereto.

This is in particular important for the transport industry. Combinations of this type comprising a rechargeable battery, which provides a considerable contribution to the electrical supply during a journey, and transportation case that provides a corresponding stowage space for freight, may be used irrespective of a vehicle.

It is thus also possible to replace the rechargeable battery quickly and it is not necessary to observe charging times for the rechargeable battery of a vehicle since, for example, a discharged battery may be removed from a vehicle and where appropriate a new rechargeable battery may be installed back in the vehicle with an associated corresponding transportation case.

The vehicle may consequently subsequently fulfil the intended task. The unloaded combination comprising a rechargeable battery and transportation case may be recharged and further used in another vehicle, for example, in a transporter or in a truck.

The combined transportation unit is consequently described independently of a vehicle.

A further use of combined transportation units of this type may be provided in ships or also in aircraft. Such a use of a combined transportation unit may also be as a container having an energy supply.

All transport facilities which are used by logistics enterprises, such as, for example, trains, may thus also be supplied with electrical energy using correspondingly combined transportation units.

The mechanical connection that combines the replaceable electrical energy storage device and the replaceable transport container may be designed both as a permanently-fixed connection or also as a reversibly releasable connection.

A “fixed connection” is generally to be understood to mean a connection that can only be separated by destroying the connection of the combined transportation unit. A “reversibly releasable connection” may, for example, be a screw or clamp connection that may generally be reused.

In the event of a rechargeable battery becoming defective, the replaceable transported goods case or accordingly the replaceable transported goods container may, for example, be placed on a different rechargeable battery and used.

In an embodiment, the transported goods case of both of the autogyro and of the combined transportation unit can, for example, comprise a closable opening. This opening can, for example, be a flap through which, for example, suitcases etc. may be introduced into the inner space of the replaceable transportation case.

In order to prevent the goods being transported from moving during transportation, the replaceable transported (goods) case may comprise a locking device and/or transportation compartments.

The locking device may be provided, for example, by belts. The transportation compartments in particular divide the available transportation space and may themselves in turn, for example, comprise flaps for closing their opening and stowing goods.

In order to provide that the combined transportation unit is replaced and consequently also that a vehicle is supplied with electrical energy or accordingly that the rechargeable battery is recharged, the replaceable electrical energy storage device may comprise an electrical connection for charging or discharging energy.

In an embodiment of the autogyro in accordance with the present invention and in an embodiment of the combined transportation unit, the ratio of a volume of the replaceable electrical energy storage device to a volume of the replaceable transported goods case is less than 1:2, in particular less than 1:3.

The space available for loading is consequently, for example, considerably greater than the volume required by the rechargeable battery.

The combined transportation unit is generally designed in the shape of a cube. This is in particular understood to mean that from a specific distance, the structure appears to be cube-shaped. The corners of the cube may also be rounded and configured so that it is not possible for points and edges to injure people.

The combined transportation unit may comprise a fork carrier receiving facility in order to replace the combined transportation unit quickly and simply using existing means.

It is consequently possible for a floor conveyor vehicle, for example, a forklift truck, to use its forks to receive the combined transportation unit and to remove the combined transportation unit from a vehicle or to place the combined transportation unit back in the vehicle.

An exemplary embodiment of the present invention is illustrated in the drawings and is explained in greater detail below. The illustrated exemplary embodiment is an autogyro having purely electrical drives.

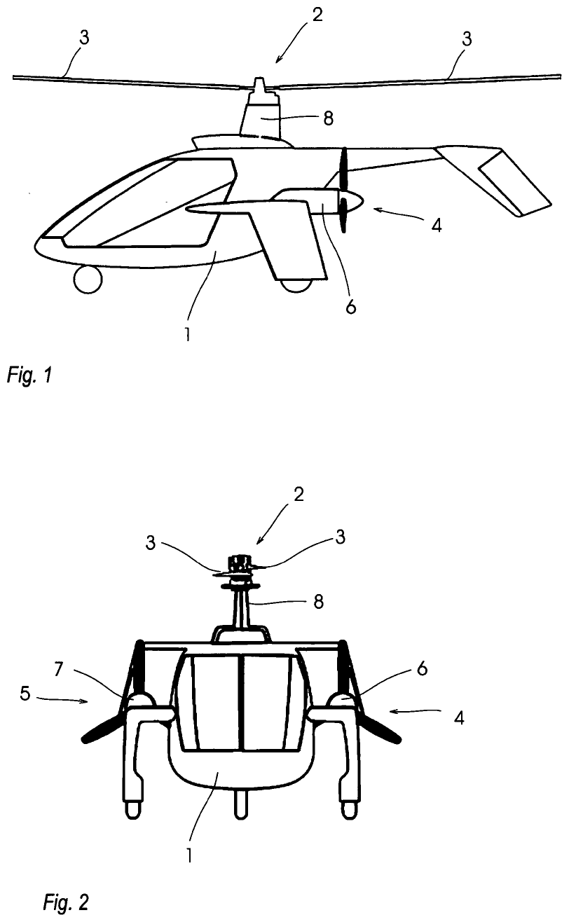

The autogyro in accordance with the present invention comprises a fuselage 1 having a rotor 2 that has non-adjustable rotor blades 3 and is arranged on a mast 8 (FIG. 1). The rotor 2 may be driven by a battery-operated electric motor (which is not illustrated in the drawings). The electric motors 6 and 7 having respective drive propellers 4 and 5 are arranged in the rear region of the fuselage 1 and protrude on both sides sidewards beyond the contour of the fuselage 1 (FIG. 2).

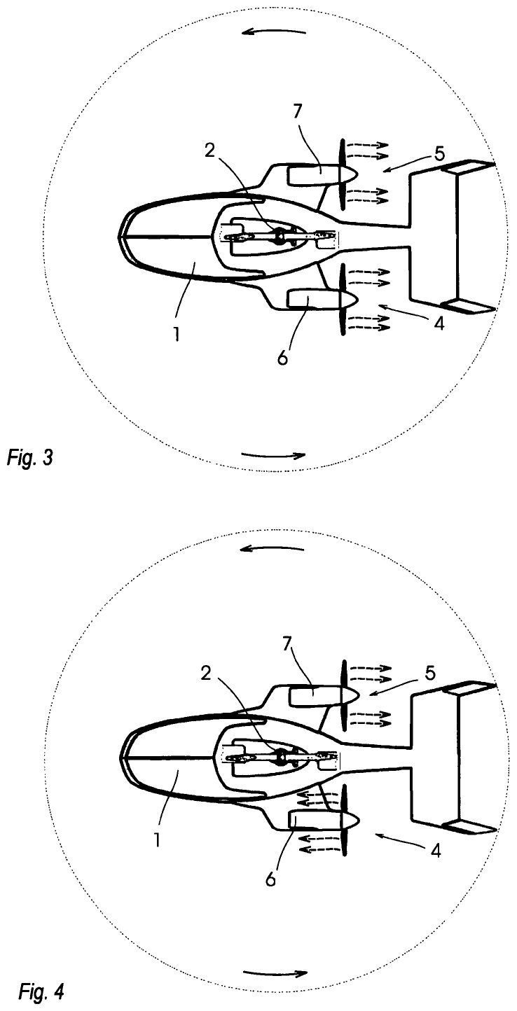

FIG. 3 illustrates a classic take-off procedure where the rotor 2 is autorotating. The direction of rotation of the rotor blades 3 and the direction of thrust of the drive propellers 4 and 5 are illustrated in this case schematically by arrows.

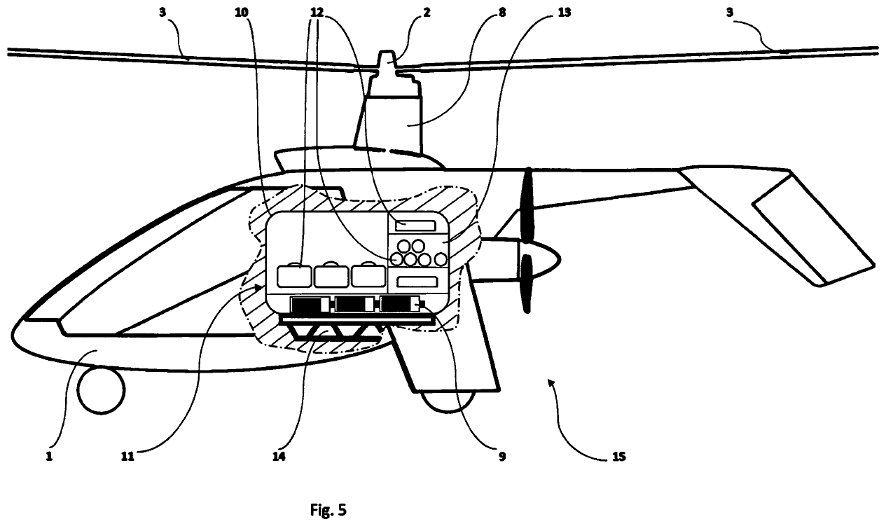

FIG. 4 illustrates the drive states in the case of a vertical take-off with the rotor 2 being motor-driven. The rotational speed of the rotor 2 is selected in this case so that it generates an uplift that is greater than the total mass and consequently the autogyro lifts up. In order to compensate the torque that is now occurring and that automatically causes the fuselage 1 to rotate about its own vertical axis, a direction of thrust is reversed in the case of the drive propeller 4 by changing the direction of rotation of the electric motor 6. By virtue of accordingly controlling the rotational speeds of the electric motors 6 and 7 in a closed-loop manner, it is possible to compensate in a controlled manner the torque that is acting on the fuselage 1. The rotor blades 3 are only illustrated in part and are implied in FIGS. 3 and 4.

An autogyro 15 comprises a fuselage 1, a rotor 2 having rotor blades 3 that are arranged on a mast 8. A hexapod 14 is fixedly connected inside the autogyro 15 to the fuselage 1. A transportation unit 11 is arranged on the hexapod 14. The transportation unit 11 comprises a rechargeable battery 9 in its lower region and a transport container 10 in its upper region. The transport container 10 additionally comprises transportation compartments 13. Goods to be transported 12, such as luggage, are placed in the transport container 10 and are accordingly secured by belts (which are not illustrated).

If the autogyro 15 now takes off vertically, the hexapod 14 is controlled so that the displacement of the transportation unit 11 causes the center of gravity of the autogyro 15 to shift so that the fuselage 1 is fundamentally oriented in the horizontal direction.

The present invention is not limited to embodiments described herein; reference should be had to the appended claims.

### LIST OF REFERENCE NUMERALS

1 Fuselage
2 Rotor
3 Rotor blades
4 Drive propeller
5 Drive propeller
6 Electric motor
7 Electric motor
8 Mast
9 Rechargeable battery
10 Transport container
11 Transportation unit
12 Goods to be transported
13 Transportation compartments
14 Hexapod
15 Autogyro

What is claimed is:

1-21. (canceled)

22. An autogyro comprising a fuselage which comprises:
a rotor which comprises,
rotor blades which are arranged on an upper face of the fuselage, the rotor blades being configured to autorotate via an airflow, and
a rotor drive which is configured to temporarily drive the rotor via a first motor.

23. The autogyro as recited in claim 22, further comprising:
a first driven, thrust-generating propulsion-generating device arranged on a first side of the fuselage so as to protrude therefrom in a horizontal direction; and
a second drive, thrust-generating propulsion-generating device arranged on a second side of the fuselage so as to protrude therefrom in the horizontal direction,
wherein,
a thrust force of the first driven, thrust-generating propulsion-generating device and a thrust force of the second driven, thrust-generating propulsion-generating device are independently adjustable from each other.

24. The autogyro as recited in claim 23, wherein, at least one of,
the first driven, thrust-generating propulsion-generating device comprises a thrust-direction reversing device which is configured to apply a torque to the autogyro via a thrust reversal, and
the second driven, thrust-generating propulsion-generating device comprises a thrust-direction reversing device which is configured to apply a torque to the autogyro via a thrust reversal.

25. The autogyro as recited in claim 24, wherein, at least one of,
the first driven, thrust-generating propulsion-generating device comprises a propeller which comprises propeller blades, and
the second driven, thrust-generating propulsion-generating device comprises a propeller which comprises propeller blades.

26. The autogyro as recited in claim 25, wherein,
a thrust force of the propeller of the first driven, thrust-generating propulsion-generating device is adjusted by at least one of adjusting the propeller blades and by changing a rotation speed of the propeller, and
a thrust force of the propeller of the second driven, thrust-generating propulsion-generating device is adjusted by at least one of adjusting the propeller blades and by changing a rotation speed of the propeller.

27. The autogyro as recited in claim 25, wherein,
each thrust-direction reversing device is provided by one respective propeller, and
each thrust-direction reversing device is configured so that the thrust reversal is performed by at least one of adjusting the propeller blades and by changing a direction of rotation of the propeller.

28. The autogyro as recited in claim 22, further comprising:
a mass adjusting device which is configured to at least one of orient the fuselage in a horizontal direction and to control a direction of the autogyro.

29. The autogyro as recited in claim 28, wherein the mass adjusting device comprises a mass element and an adjusting element.

30. The autogyro as recited in claim 29, wherein the mass element is a transport container.

31. The autogyro as recited in claim 30, wherein the transport container is at least one of a freight box, an energy storage device, and a drive unit.

32. The autogyro as recited in claim 31, wherein,
the energy storage device is a battery, and
the drive unit is a second motor.

33. The autogyro as recited in claim 29, wherein the adjusting element comprises an actuator or a hexapod.

34. The autogyro as recited in claim 28, further comprising:
a control device which is configured to control the mass adjusting device in at least one of an open-loop manner and in a closed-loop manner.

35. The autogyro as recited in claim 28, further comprising:
a position sensor which is configured to determine a horizontal orientation of the fuselage.

36. The autogyro as recited in in claim 22, further comprising:
an electric drive or a hybrid drive,
wherein,
the electric drive or the hybrid drive comprises a replaceable electrical energy storage device.

37. The autogyro as recited in claim 36, wherein the replaceable electrical energy storage device is a rechargeable battery.

38. The autogyro as recited in claim 36, wherein the replaceable electrical energy storage device comprises an electrical connection for charging or discharging energy.

39. The autogyro as recited in claim 36, further comprising:
a replaceable transported goods case,
wherein,
the replaceable transported goods case is coupled to the replaceable electrical energy storage device via a mechanical connection so as to provide a combined transportation unit for transporting freight and for supplying energy to the electric drive or to the hybrid drive, and
the combined transportation unit comprising the replaceable transported goods case coupled to the replaceable electrical energy storage device via the mechanical connection is configured to be loaded or unloaded as a whole.

40. The autogyro as recited in claim 39, wherein the mechanical connection is a permanently-fixed connection or a reversibly releasable connection.

41. The autogyro as recited in claim 39, characterized in that the replaceable transported goods case comprises a closable opening.

42. The autogyro as recited in claim 39, wherein the replaceable transportation goods case comprises at least one of a locking device and at least one transportation compartment.

43. The autogyro as recited in claim 39, wherein a ratio of a volume of the replaceable electrical energy storage device to a volume of the replaceable transported goods case is less than 1:2.

44. The autogyro as recited in claim 39, wherein the combined transportation unit is substantially cube-shaped.

45. The autogyro as recited in claim 39, wherein the combined transportation unit comprises a fork carrier receiving facility.
